(19) United States
(12) Patent Application Publication
(10) Pub. No.: US 2022/0178624 A1
(43) Pub. Date: Jun. 9, 2022

(54) HEAT STORAGE DEVICE

(71) Applicant: DENSO CORPORATION, Kariya-city (JP)

(72) Inventors: Takuya FUSE, Kariya-city (JP); Toru OKAMURA, Kariya-city (JP); Kuniyoshi TANIOKA, Kariya-city (JP)

(21) Appl. No.: 17/680,735

(22) Filed: Feb. 25, 2022

Related U.S. Application Data
(62) Division of application No. 16/926,006, filed on Jul. 10, 2020.
Application No. 16/926,006 is a continuation of application No. PCT/JP2018/042782, filed on Nov. 20, 2018.

(30) Foreign Application Priority Data
Jan. 15, 2018 (JP) 2018-004398

(51) Int. Cl. F28D 20/00; B60H 1/32; B60H 1/04; F01P 3/04; F01P 7/14

(52) U.S. Cl. CPC F28D 20/0034; B60H 1/32011; B60H 1/04; F28D 2020/0078; F01P 7/14; F01P 2007/146; F28D 2020/0013; F01P 3/04

(57) ABSTRACT

A heat storage device includes a heat storage, a first flow passage, a second flow passage and a flow rate regulator. The heat storage stores heat released from coolant. The first flow passage is placed in a circulation path that conducts the coolant. The heat storage is installed in the first flow passage. The second flow passage conducts the coolant and bypasses the heat storage. The flow rate regulator adjusts a flow rate ratio that is a ratio of a second flow rate of the coolant, which flows in the second flow passage, relative to a first flow rate of the coolant, which flows in the first flow passage. The flow rate regulator reduces the first flow rate when a temperature of the coolant is decreased.

### CROSS REFERENCE TO RELATED APPLICATIONS

This application is a divisional application of U.S. patent application Ser. No. 16/926,006 filed on Jul. 10, 2020, which is a continuation application of International Patent Application No. PCT/JP2018/042782 filed on Nov. 20, 2018, which designated the U.S. and claims the benefit of priority from Japanese Patent Application No. 2018-004398 filed on Jan. 15, 2018. The entire disclosures of all of the above applications are incorporated herein by reference.

### TECHNICAL FIELD

The present disclosure relates to a heat storage device.

### BACKGROUND

Previously, there is proposed a cooling system that is configured to cool an engine. The cooling system includes a radiator and a heat storage device. The radiator is a heat-releasing heat exchanger that exchanges heat between coolant heated by exhaust heat of the engine and outside air to release the exhaust heat of the engine to the outside air. The heat storage device compensates a shortage in a heat releasing capacity of the radiator. In this cooling system, when the amount of heat generated by the engine is large, the exhaust heat released from the engine is stored in the heat storage device to compensate the shortage in the heat releasing capacity of the radiator and limit a rapid temperature increase of the coolant.

### SUMMARY

This section provides a general summary of the disclosure, and is not a comprehensive disclosure of its full scope or all of its features.

According to the present disclosure, there is provided a heat storage device that includes a heat storage, a first flow passage, a second flow passage and a flow rate regulator. The heat storage is configured to store heat released from coolant. The first flow passage is placed in a circulation path that conducts the coolant, and the heat storage is installed in the first flow passage. The second flow passage is configured to conduct the coolant and bypass the heat storage. The flow rate regulator is configured to reduce a flow rate of the coolant conducted through the first flow passage when a temperature of the coolant is decreased.

### BRIEF DESCRIPTION OF DRAWINGS

The drawings described herein are for illustrative purposes only of selected embodiments and not all possible implementations, and are not intended to limit the scope of the present disclosure.

FIG. 1 is a perspective view of a heat storage device of a first embodiment.

FIG. 2 is an overall configuration diagram of a refrigeration cycle apparatus that includes the heat storage device of the first embodiment.

FIG. 3 is an overall configuration diagram of a heat exchanger that includes a heat storage device of a second embodiment.

FIG. 4 is an overall configuration diagram of a refrigeration cycle apparatus that includes the heat storage device of the second embodiment.

FIG. 5 is an overall configuration diagram of a refrigeration cycle apparatus of another embodiment that includes a heat storage device installed in a high-temperature-side coolant circuit.

### DETAILED DESCRIPTION

Previously, there is proposed a cooling system that is configured to cool an engine. The cooling system includes a radiator and a heat storage device. The radiator is a heat-releasing heat exchanger that exchanges heat between coolant heated by exhaust heat of the engine and outside air to release the exhaust heat of the engine to the outside air. The heat storage device compensates a shortage in a heat releasing capacity of the radiator. In this cooling system, when the amount of heat generated by the engine is large, the exhaust heat released from the engine is stored in the heat storage device to compensate the shortage in the heat releasing capacity of the radiator and limit a rapid temperature increase of the coolant.

However, the above heat storage device is constructed by simply placing a heat storage material in a coolant circuit, so that the amount of stored heat cannot be adjusted as necessary. Thus, even in a state where the exhaust heat of the engine can be sufficiently released at the radiator, the exhaust heat of the engine is absorbed by the heat storage device. Therefore, it would happen that when a shortage in the heat releasing capacity of the radiator occurs upon an increase in the amount of heat generated by the engine, the heat storage device cannot absorb the sufficient amount of heat released from the engine, and thereby the rapid temperature increase of the coolant cannot be limited.

According to one aspect of the present disclosure, there is provided a heat storage device for a cooling system that includes: a heat exchanger, which is configured to release heat from coolant that is heated by a heat generating device at a time of operating the heat generating device; and a circulation path, which is configured to circulate the coolant between the heat generating device and the heat exchanger. The heat storage device includes: a heat storage, which is configured to store the heat released from the coolant; a first flow passage, which is placed in a portion of the circulation path that conducts the coolant, while the heat storage is installed in the first flow passage; a second flow passage, which is configured to conduct the coolant and bypass the heat storage; and a flow rate regulator that is configured to adjust a flow rate ratio that is a ratio of a second flow rate of the coolant, which flows in the second flow passage, relative to a first flow rate of the coolant, which flows in the first flow passage. The flow rate regulator is configured to reduce the first flow rate when a temperature of the coolant is decreased.

With the above configuration, when the temperature of the coolant is decreased, the first flow rate is reduced, and thereby the flow rate of the coolant supplied to the heat storage is reduced. Therefore, it is possible to limit the unnecessary heat storage at the heat storage in the state where the heat releasing capacity of the heat exchanger has not become insufficient, and the temperature of the coolant flowing in the circulation path is low, and thereby it is not necessary to absorb the heat from the coolant at the heat storage.

Thus, the heat storage can sufficiently absorb the heat from the coolant when the heat storage needs to absorb the heat from the coolant due to an increase in the temperature of the coolant flowing in the circulation path in the state where the heat releasing capacity of the heat exchanger is insufficient. As a result, it is possible to provide the heat storage device that can limit the rapid temperature increase of the coolant.

Now, various embodiments of the present disclosure will be described with reference to the accompanying drawings.

### First Embodiment

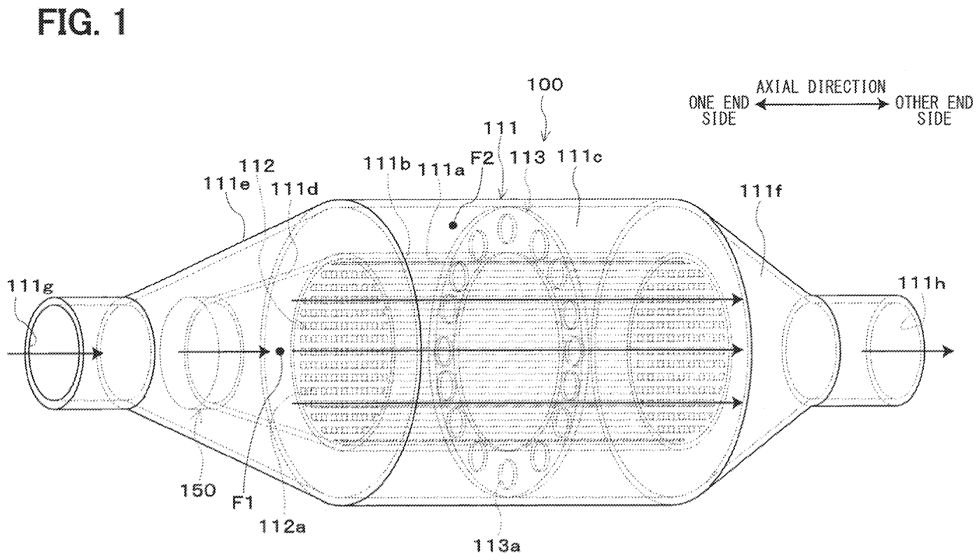

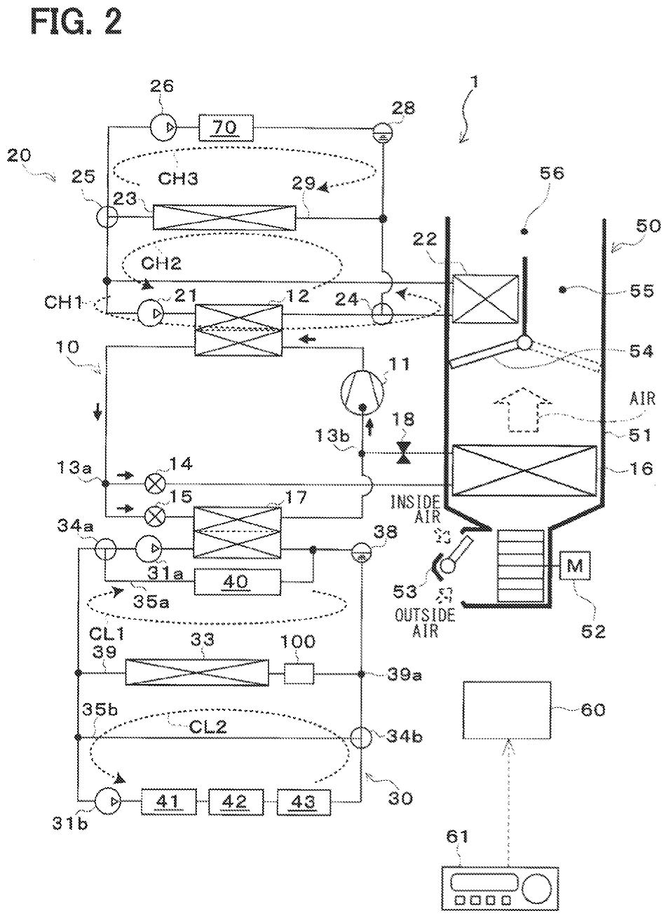

A heat storage device 100 of a first embodiment will be described with reference to FIGS. 1 and 2. The heat storage device 100 of the first embodiment is applied to a hybrid vehicle that can obtain a drive force for driving a vehicle from both an internal combustion engine 70 and a motor generator 43. The heat storage device 100 is applied to a refrigeration cycle apparatus 1 that is used for air conditioning of a vehicle cabin and for cooling various in-vehicle devices at this hybrid vehicle.

Furthermore, this hybrid vehicle is configured as a so-called plug-in hybrid vehicle.

In the plug-in hybrid vehicle, an electric power, which is supplied from an external electric power source (e.g., a commercial electric power source), can be charged to a battery 40 installed to the vehicle in a state where the vehicle is stopped. Like at the time of starting the traveling of the vehicle, when the remaining amount of electricity stored in the battery 40 is equal to or larger than a reference remaining amount, which is required for traveling of the vehicle in an EV traveling mode, the vehicle is driven in the EV traveling mode. The EV traveling mode is a traveling mode for driving the vehicle with a drive force outputted from the motor generator 43.

In the case of the plug-in hybrid vehicle, when the remaining amount of electricity stored in the battery 40 is less than the reference remaining amount, the vehicle is driven in an HV traveling mode. The HV traveling mode is mainly an EG traveling mode for driving the vehicle with a drive force outputted mainly from the engine 70. However, in the HV traveling mode, when a vehicle traveling load reaches a high load, a traveling electric motor is operated to assist the engine 70.

In the case of the plug-in hybrid vehicle, by switching between the EV traveling mode and the HV traveling mode, it is possible to suppress the fuel consumption of the engine 70 and improve the fuel consumption of the vehicle in comparison to an ordinary vehicle, in which the drive force for driving the vehicle is obtained only from the engine 70.

Further, as shown in the overall configuration diagram of FIG. 2, the heat storage device 100 of the present embodiment is installed in a low-temperature-side coolant circuit 30 that has a function of a cooling system that cools, for example, the battery 40 (serving as an in-vehicle device) at the refrigeration cycle apparatus 1. The heat storage device 100 has a function of storing the heat released from the coolant in the low-temperature-side coolant circuit 30.

Prior to description of a configuration of the refrigeration cycle apparatus 1 in detail, a configuration of the heat storage device 100 of the present embodiment will be described in detail. As shown in FIG. 1, the heat storage device 100 of the first embodiment includes a container 111, a heat storage 112, a support member 113 and a flow rate regulator 150. In the following description, a left-to-right direction of FIG. 1 will be referred to as an axial direction. Furthermore, the left side of FIG. 1 will be referred to as one end side, and the right side of FIG. 1 will be referred to as the other end side. Also, in FIG. 1, a direction, which is perpendicular to the axial direction, will be referred to as a radial direction.

The container 111 is made of synthetic resin (specifically, polypropylene) that has excellent heat resistance. Alternatively, the container 111 may be made of metal (specifically, aluminum).

The container 111 includes an inner pipe portion 111b, an outer pipe portion 111c, a one-end-side inner tapered pipe portion 111d, a one-end-side outer tapered pipe portion 111e, an other-end-side outer tapered pipe portion 111f, a flow inlet 111g and a flow outlet 111h.

The inner pipe portion 111b is shaped in a cylindrical pipe form. The outer pipe portion 111c is shaped in a cylindrical pipe form. The outer pipe portion 111c is placed on a radially outer side of the inner pipe portion 111b and is coaxial with the inner pipe portion 111b.

The one-end-side inner tapered pipe portion 111d is connected to an end of the inner pipe portion 111b located on the one-end side and is shaped in a tapered pipe form such that an inner diameter and an outer diameter of the one-end-side inner tapered pipe portion 111d are progressively reduced toward the one-end side. The one-end-side outer tapered pipe portion 111e is connected to an end of the outer pipe portion 111c located on the one-end side and is shaped in a tapered pipe form such that an inner diameter and an outer diameter of the one-end-side outer tapered pipe portion 111e are progressively reduced toward the one-end side. The one-end-side outer tapered pipe portion 111e is placed on a radially outer side of the one-end-side inner tapered pipe portion 111d and is coaxial with the one-end-side inner tapered pipe portion 111d.

The other-end-side outer tapered pipe portion 111f is connected to another end of the outer pipe portion 111c located on the other-end side and is shaped in a tapered pipe form such that an inner diameter and an outer diameter of the other-end-side outer tapered pipe portion 111f are progressively reduced toward the other-end side. The flow inlet 111g is shaped in a cylindrical tubular form and is formed at an end of container 111 located on the one-end side, and the flow inlet 111g is connected to the one-end-side outer tapered pipe portion 111e. The flow outlet 111h is shaped in a cylindrical tubular form and is formed at another end of the container 111 located on the other-end side, and the flow outlet 111h is connected to an end of the other-end-side outer tapered pipe portion 111f located on the other-end side.

An inside space of the one-end-side inner tapered pipe portion 111d and an inside space of the inner pipe portion 111b serve as a first flow passage F1, in which the heat storage 112 described later is installed. A space between the one-end-side outer tapered pipe portion 111e and the one-end-side inner tapered pipe portion 111d and a space between the outer pipe portion 111c and the inner pipe portion 111b serve as a second flow passage F2, which conducts the coolant and bypasses the heat storage 112.

The support member 113 is placed between the inner pipe portion 111b and the outer pipe portion 111c to securely support the inner pipe portion 111b relative to the outer pipe portion 111c. In the present embodiment, the support member 113 is shaped in a circular ring plate form and has a plurality of passage holes 113a, which extend through the support member 113 and are arranged at constant angular intervals in a circumferential direction of the support member 113. The coolant, which flows in the second flow passage F2, passes through the passage holes 113a and is conducted to the flow outlet 111h.

The heat storage 112 contacts the coolant and exchanges heat with the coolant to store the heat. The heat storage 112 is placed in a receiving space 111a that is a space in the inner pipe portion 111b. Specifically, the heat storage 112 is placed in the first flow passage F1. The heat storage 112 is immovably fixed to the inner pipe portion 111b. The second flow passage F2 described above conducts the coolant and bypasses the heat storage 112.

The heat storage 112 has a plurality of flow passages 112a that extend in the axial direction of the heat storage 112. The flow passages 112a are formed in parallel with a flow direction of the coolant. A cross-section of each of the flow passages 112a is shaped in a rectangular form. Alternatively, the cross section of each of the flow passages 112a may be shaped in another polygonal form (specifically, a hexagonal form) or a circular form.

Furthermore, the heat storage 112 is formed such that a large number of fine spherical heat storage material pieces are joined together by a skeletal material. The skeletal material is synthetic resin (specifically, polypropylene) that has excellent heat resistance, and the skeletal material is a sensible heat storage material that does not undergo a phase change at the time of storing the heat.

Each of the heat storage material pieces is formed such that a latent heat storage material (also known as a phase change material), which undergoes a phase change at the time of storing the heat, is encapsulated in a spherical capsule. The capsule is made of the same material as the skeletal material (i.e., polypropylene) and is the sensible heat storage material that does not undergo the phase change at the time of storing the heat. Paraffin, hydrate or the like may be used as the latent heat storage material.

The latent heat storage material undergoes the phase change at its melting point to absorb or release heat. The latent heat storage material absorbs the heat from the coolant and undergoes a phase change in a temperature range, in which the temperature of the coolant is higher than the melting point of the latent heat storage material. This allows the latent heat storage material to store the greater amount of heat released from the coolant in comparison to the sensible heat storage material. In contrast, the latent heat storage material releases the heat to the coolant and undergoes a phase change in a temperature range, in which the temperature of the coolant is lower than the melting point of the latent heat storage material. A latent heat storage material having a melting point of about 40 degrees Celsius is used as the latent heat storage material of the present embodiment.

The skeletal material and the capsules have heat resistance. Specifically, the skeletal material and the capsules are in a solid state in an assumed temperature range (specifically, −5 degrees Celsius to 60 degrees Celsius) of the coolant that flows through the low-temperature-side coolant circuit 30. Therefore, in the assumed temperature range of the coolant, the entire heat storage is in the solid state and becomes a solid-state member that does not change its external shape.

In the inside of the container 111, the flow rate regulator 150 is located on the upstream side of the heat storage 112. Specifically, the flow rate regulator 150 is placed at the opening side of the one-end-side inner tapered pipe portion 111d, i.e., at the flow inlet side of the first flow passage F1.

The flow rate regulator 150 is configured to adjust a flow rate ratio that is a ratio of a second flow rate fr2 of the coolant, which flows in the second flow passage F2, relative to a first flow rate fr1 of the coolant, which flows in the first flow passage F1.

In the present embodiment, a thermostatic valve is used as the flow rate regulator 150. The thermostatic valve opens and closes the coolant passage by displacing a valve element through use of a volume change of a thermo-wax (temperature sensitive member) in response to a change in the temperature. The flow rate regulator 150 of the present embodiment opens the coolant passage when the temperature of the coolant, which flows into the flow rate regulator 150, becomes equal to or higher than a predetermined temperature (specifically, 40 degrees Celsius). Furthermore, the flow rate regulator 150 increases a valve opening degree in response to an increase in the temperature of the coolant.

In other words, the flow rate regulator 150 reduces a size of a passage cross section, which conducts the coolant, in response to a decrease in the temperature of the coolant flowing in the flow rate regulator 150. It is desirable that the predetermined temperature is set to a temperature, which is equal to or slightly lower than a lowest attainable temperature that is attainable by the coolant flowing into the flow rate regulator 150 at the time when a heat releasing capacity of the low-temperature-side radiator 33 is insufficient.

Next, the refrigeration cycle apparatus 1, in which the heat storage device 100 is installed, will be described with reference to FIG. 2. As described above, the refrigeration cycle apparatus 1 is applied to the hybrid vehicle that can obtain the drive force for driving the vehicle from the engine 70 and the motor generator 43.

An operation mode of the refrigeration cycle apparatus 1 for air conditioning the vehicle cabin can be switched among a cooling mode, a dehumidifying and heating mode and a heating mode. The cooling mode is an operation mode where the blowing air to be blown into the vehicle cabin (serving as an air conditioning subject space) is cooled and is discharged into the vehicle cabin. The dehumidifying and heating mode is an operation mode where the blowing air, which is cooled and is dehumidified, is reheated and is discharged into the vehicle cabin. The heating mode is an operation mode where the blowing air is heated and is discharged into the vehicle cabin.

As shown in FIG. 2, the refrigeration cycle apparatus 1 includes a refrigeration cycle 10, a high-temperature-side coolant circuit 20, a low-temperature-side coolant circuit 30, a cabin air conditioning unit 50, a control device (controller) 60 and an operating device 61.

First of all, the refrigeration cycle 10 will be described. The refrigeration cycle 10 is a vapor compression refrigeration cycle. The refrigeration cycle 10 forms a subcritical refrigeration cycle, in which a high-pressure-side refrigerant pressure is not increased beyond a critical pressure of the refrigerant. The refrigeration cycle 10 uses an HFC refrigerant (specifically, R134a) as the refrigerant of the refrigeration cycle 10. A refrigerant oil, which lubricates a compressor 11, is mixed in the refrigerant. A portion of the refrigerant oil is circulated along with the refrigerant in the cycle.

The compressor 11 suctions, compresses and discharges the refrigerant in the refrigeration cycle 10. The compressor 11 is an electric compressor, in which a fixed displacement type compression mechanism having a fixed discharge capacity is rotated by an electric motor. A rotational speed (i.e., a refrigerant discharge capacity) of the compressor 11 is controlled by a control signal outputted from the control device 60 described later.

An inlet of a refrigerant passage of a coolant-refrigerant heat exchanger 12 is connected to a discharge outlet of the compressor 11. The coolant-refrigerant heat exchanger 12 has: the refrigerant passage, which conducts the high-pressure refrigerant discharged from the compressor 11; and a coolant passage, which conducts the coolant serving as a high-temperature-side heat medium that is circulated through the high-temperature-side coolant circuit 20. The coolant-refrigerant heat exchanger 12 is a heat exchanger that exchanges heat between the high-pressure refrigerant, which is conducted through the refrigerant passage of the coolant-refrigerant heat exchanger 12, and the coolant, which is conducted through the coolant passage of the coolant-refrigerant heat exchanger 12, to heat the coolant.

A refrigerant flow inlet of a branching portion 13a is connected to an outlet of the refrigerant passage of the coolant-refrigerant heat exchanger 12. The branching portion 13a is a portion, at which the flow of the high-pressure refrigerant outputted from the refrigerant passage of the coolant-refrigerant heat exchanger 12 is branched. The branching portion 13a has a three-way joint structure that has three refrigerant inlet/outlet openings, which communicate with each other. One of the three refrigerant inlet/outlet openings is formed as a refrigerant inlet opening, and two of the three refrigerant inlet/outlet openings are formed as refrigerant outlet openings.

A refrigerant inlet of a cabin evaporator 16 is connected to one of the refrigerant outlet openings of the branching portion 13a through a cooling expansion valve 14. An inlet of a refrigerant passage of the chiller 17 is connected to the other one of the refrigerant outlet openings of the branching portion 13a through a heat-absorbing expansion valve 15.

The cooling expansion valve 14 is a cooling depressurization device that depressurizes the refrigeration outputted from the one of the refrigerant outlet openings of the branching portion 13a at least in the cooling mode. Furthermore, the cooling expansion valve 14 is a cooling flow rate regulator that adjusts a flow rate of the refrigerant to be flown into the cabin evaporator 16 located on a downstream side of the cooling expansion valve 14.

The cooling expansion valve 14 is an electric variable flow rate restrictor mechanism that includes: a valve element, which can change an opening degree of a flow-restricting opening of the cooling expansion valve 14; and an electric actuator (specifically, a stepping motor), which can change an opening degree of this valve element. An operation of the cooling expansion valve 14 is controlled by a control signal (specifically, a control pulse) outputted from the control device 60.

Furthermore, the cooling expansion valve 14 has a full closing function for closing the refrigerant passage by changing the valve opening degree to a full closing degree. With this full closing function, the cooling expansion valve 14 can switch between: a refrigerant circuit, in which the refrigerant is supplied to the cabin evaporator 16; and a refrigerant circuit, in which the refrigerant is not supplied to the cabin evaporator 16. Specifically, the cooling expansion valve 14 also has a function of a circuit switching device that switches the refrigerant circuit.

The cabin evaporator 16 is a heat exchanger that exchanges heat between: the low-pressure refrigerant, which is depressurized by the cooling expansion valve 14; and the blowing air. The cabin evaporator 16 is a cooling heat exchanger that evaporates the low-pressure refrigerant to cool the blowing air at least in the cooling mode. The cabin evaporator 16 is placed at an inside of a casing 51 of the cabin air conditioning unit 50 described later.

An inlet of the evaporation pressure regulating valve 18 is connected to a refrigerant outlet of the cabin evaporator 16. The evaporation pressure regulating valve 18 is an evaporation pressure regulator that is configured to maintain a refrigerant evaporation pressure at the cabin evaporator 16 to a predetermined reference pressure or higher. The evaporation pressure regulating valve 18 has a mechanical variable flow rate restrictor mechanism that is configured to increase a valve opening degree in response to an increase in a refrigerant pressure at the outlet of the cabin evaporator 16.

In the present embodiment, the evaporation pressure regulating valve 18 is configured to maintain the refrigerant evaporation temperature of the cabin evaporator 16 at or higher than a frost limiting reference temperature (1 degrees Celsius in the present embodiment) that can limit frost formation at the cabin evaporator 16.

A refrigerant inlet opening of the merging portion 13b is connected to an outlet of the evaporation pressure regulating valve 18. The merging portion 13b is a portion, at which the flow of the refrigerant outputted from the evaporation pressure regulating valve 18 and the flow of the refrigerant outputted from the chiller 17 are merged. Like the branching portion 13a, the merging portion 13b has a three-way joint structure that has three refrigerant inlet/outlet openings. In the merging portion 13b, two of the three refrigerant inlet/outlet openings are formed as refrigerant inlet openings, and one of the three refrigerant inlet/outlet openings is formed as a refrigerant outlet opening. A suction inlet of the compressor 11 is connected to the refrigerant outlet opening of the merging portion 13b.

The heat-absorbing expansion valve 15 is a heat absorbing depressurization device that depressurizes the refrigeration outputted from the other one of the refrigerant outlet openings of the branching portion 13a at least in the heating mode. Furthermore, the heat-absorbing expansion valve 15 is a heat absorbing flow rate regulator that adjusts a flow rate of the refrigerant to be supplied to the chiller 17 located on a downstream side of the heat-absorbing expansion valve 15.

A basic structure of the heat-absorbing expansion valve 15 is substantially the same as that of the cooling expansion valve 14. Therefore, the heat-absorbing expansion valve 15 is the electric variable flow rate restrictor mechanism that has the full closing function. Furthermore, the heat-absorbing expansion valve 15 also has a function of a circuit switching device that switches between: a refrigerant circuit, in which the refrigerant is supplied to a refrigerant passage of the chiller 17; and a refrigerant circuit, in which the refrigerant is not supplied to the refrigerant passage of the chiller 17. The chiller 17 is a heat exchanger that exchanges heat between: the low-pressure refrigerant, which is depressurized by the heat-absorbing expansion valve 15; and the coolant serving as the low-temperature-side heat medium, which is circulated through the low-temperature-side coolant circuit 30. The chiller 17 has the refrigerant passage, which conducts the low-pressure refrigerant that is depressurized by the heat-absorbing expansion valve 15; and a coolant passage, which conducts the coolant that is circulated through the low-temperature-side coolant circuit 30.

The chiller 17 is an evaporating unit that exchanges heat between the low-pressure refrigerant, which is conducted through the refrigerant passage of the chiller 17, and the coolant, which is conducted through the coolant passage of the chiller 17, to evaporate the low-pressure refrigerant at least in the heating mode. In other words, the chiller 17 is a heat-absorbing heat exchanger, which evaporates the low-pressure refrigerant to let the low-pressure refrigerant to absorb the heat of the coolant at least in the heating mode. The other one of the refrigerant inlet openings of the merging portion 13b is connected to an outlet of the refrigerant passage of the chiller 17.

Next, the high-temperature-side coolant circuit 20 will be described. The high-temperature-side coolant circuit 20 is a heat medium circuit that circulate the coolant, which is the high-temperature-side heat medium, mainly between the coolant-refrigerant heat exchanger 12 and a heater core 22, between the coolant-refrigerant heat exchanger 12 and a high-temperature-side radiator 23, and between the engine 70 and the high-temperature-side radiator 23. A solution, which contains ethylene glycol, an antifreeze solution or the like may be used as the coolant.

The high-temperature-side coolant circuit 20 includes a coolant passage of the coolant-refrigerant heat exchanger 12, a high-temperature-side heat medium pump 21, the heater core 22, the high-temperature-side radiator 23, a first high-temperature-side flow rate regulating valve 24, a second high-temperature-side flow rate regulating valve 25, an engine coolant pump 26 and a high-temperature-side reservoir tank 28. Furthermore, a coolant jacket, which is a coolant passage of the engine 70, is connected to the high-temperature-side coolant circuit 20.

The engine 70 generates a drive force by combusting hydrocarbon fuel such as gasoline or light oil. The engine 70 generates heat in response to the combustion of the hydrocarbon fuel. Thus, the engine 70 is a heat generating device that generates the heat at the time of operating it and heats the coolant, which flows in the inside of the engine 70. The coolant is conducted through the coolant jacket, so that the engine 70 is cooled.

The high-temperature-side coolant circuit 20 mainly has three circulation paths that circulate the coolant, i.e., a first high-temperature circulation path CH1, a second high-temperature circulation path CH2 and a third high-temperature circulation path CH3.

In the first high-temperature circulation path CH1, the coolant is circulated through mainly the high-temperature-side heat medium pump 21, the coolant passage of the coolant-refrigerant heat exchanger 12, the first high-temperature-side flow rate regulating valve 24 and the heater core 22 in this order. In the second high-temperature circulation path CH2, the coolant is circulated through mainly the high-temperature-side heat medium pump 21, the coolant passage of the coolant-refrigerant heat exchanger 12, the first high-temperature-side flow rate regulating valve 24, the high-temperature-side radiator 23 and the second high-temperature-side flow rate regulating valve 25 in this order.

The coolant, which is circulated through the first high-temperature circulation path CH1 and the second high-temperature circulation path CH2 is pumped by the high-temperature-side heat medium pump 21. Therefore, the coolant, which is circulated in the first high-temperature circulation path CH1, and the coolant, which is circulated in the second high-temperature circulation path CH2, are mixed in the high-temperature-side heat medium pump 21.

In the third high-temperature circulation path CH3, the coolant is circulated through the engine coolant pump 26, the engine 70, the high-temperature-side reservoir tank 28, the high-temperature-side radiator 23 and the second high-temperature-side flow rate regulating valve 25 in this order.

The second high-temperature circulation path CH2 and the third high-temperature circulation path CH3 have a high-temperature-side radiator flow passage 29, which is a common passage that is common to the second high-temperature circulation path CH2 and the third high-temperature circulation path CH3. Therefore, the coolant, which is circulated in the second high-temperature circulation path CH2, and the coolant, which is circulated in the third high-temperature circulation path CH3, are mixed in the high-temperature-side radiator flow passage 29. Thus, the coolant, which is circulated in the first high-temperature circulation path CH1, the coolant, which is circulated in the second high-temperature circulation path CH2, and the coolant, which is circulated in the third high-temperature circulation path CH3, are mixed.

The high-temperature-side heat medium pump 21 is a coolant pump that pumps the coolant to an inlet of the coolant passage of the coolant-refrigerant heat exchanger 12. The high-temperature-side heat medium pump 21 is an electric pump, a rotational speed (i.e., a pumping capacity) of which is controlled by a control voltage outputted from the control device 60.

One flow inlet of the first high-temperature-side flow rate regulating valve 24 is connected to an outlet of the coolant passage of the coolant-refrigerant heat exchanger 12. The first high-temperature-side flow rate regulating valve 24 is an electric three-way flow rate regulating valve that includes the one flow inlet and two flow outlets while a ratio between sizes of passage cross sections of the two flow outlets can be linearly adjusted. An operation of the first high-temperature-side flow rate regulating valve 24 is controlled by a control signal outputted from the control device 60.

A coolant inlet of the heater core 22 is connected to one of the flow outlets of the first high-temperature-side flow rate regulating valve 24. A flow inlet of the high-temperature-side radiator 23 is connected to the other one of the flow outlets of the first high-temperature-side flow rate regulating valve 24.

In the high-temperature-side coolant circuit 20, the first high-temperature-side flow rate regulating valve 24 has a function of linearly adjusting a flow rate ratio between a flow rate of the coolant supplied to the heater core 22 from the coolant passage of the coolant-refrigerant heat exchanger 12 and a flow rate of the coolant supplied to the high-temperature-side radiator 23 from the coolant passage of the coolant-refrigerant heat exchanger 12.

The heater core 22 is a heat exchanger that exchanges heat between the coolant, which is heated by the coolant-refrigerant heat exchanger 12, and the blowing air, which is passed through the cabin evaporator 16, to heat the blowing air. The heater core 22 is located at the inside of the casing 51 of the cabin air conditioning unit 50. A suction inlet of the high-temperature-side heat medium pump 21 is connected to a coolant outlet of the heater core 22.

The high-temperature-side radiator 23 is installed in the high-temperature-side radiator flow passage 29. The high-temperature-side radiator 23 is a heat exchanger that exchanges heat between the coolant, which is heated by the coolant-refrigerant heat exchanger 12, and the outside air, which is blown by an outside-air fan (not shown), to release the heat of the coolant to the outside air.

The high-temperature-side radiator 23 is located at a font side of an engine room located on an inner side of a vehicle hood. Therefore, a traveling wind can be applied to the high-temperature-side radiator 23 when the vehicle is traveling. The high-temperature-side radiator 23 may be formed integrally with, for example, the coolant-refrigerant heat exchanger 12.

A flow inlet of the second high-temperature-side flow rate regulating valve 25 is connected to a coolant outlet of the high-temperature-side radiator 23. The suction inlet of the high-temperature-side heat medium pump 21 and the suction inlet of the engine coolant pump 26 are connected to the coolant outlet of the high-temperature-side radiator 23 through the second high-temperature-side flow rate regulating valve 25.

The second high-temperature-side flow rate regulating valve 25 is an electric three-way flow rate regulating valve that includes one flow inlet and two flow outlets while a ratio between sizes of passage cross sections of the two flow outlets can be linearly adjusted. An operation of the second high-temperature-side flow rate regulating valve 25 is controlled by a control signal outputted from the control device 60.

A flow inlet of the high-temperature-side heat medium pump 21 is connected to the one of the flow outlets of the second high-temperature-side flow rate regulating valve 25. A suction inlet of the engine coolant pump 26 is connected to the other one of the flow outlets of the second high-temperature-side flow rate regulating valve 25.

In the high-temperature-side coolant circuit 20, the second high-temperature-side flow rate regulating valve 25 has a function of linearly adjusting a flow rate ratio between a flow rate of the coolant supplied to the high-temperature-side heat medium pump 21 from the high-temperature-side radiator 23 and a flow rate of the coolant supplied to the engine coolant pump 26 from the high-temperature-side radiator 23.

The engine coolant pump 26 is a coolant pump that pumps the coolant to a coolant inlet of the coolant jacket of the engine 70. The engine coolant pump 26 is an electric pump, a rotational speed (i.e., a pumping capacity) of which is controlled by a control voltage outputted from the control device 60.

A coolant inlet of the high-temperature-side reservoir tank 28 is connected to a coolant outlet of the coolant jacket of the engine 70. The high-temperature-side reservoir tank 28 stores the coolant and absorbs a change in a volume of the coolant caused by thermal expansion and contraction of the coolant. The coolant outlet of the engine 70 is connected to the coolant inlet of the high-temperature-side reservoir tank 28.

Therefore, in the high-temperature-side coolant circuit 20, the first high-temperature-side flow rate regulating valve 24 adjusts the flow rate of the coolant supplied to the heater core 22, so that the amount of heat released from the coolant to the blowing air at the heater core 22 can be adjusted, i.e., the heating amount of the blowing air at the heater core 22 can be adjusted. Specifically, in the present embodiment, the coolant-refrigerant heat exchanger 12 and the other constituent components of the high-temperature-side coolant circuit 20 form a heating unit that heats the blowing air while using the refrigerant, which is discharged from the compressor 11, is used as a heat source.

Furthermore, in the high-temperature-side coolant circuit 20, the second high-temperature-side flow rate regulating valve 25 adjusts the flow rate of the coolant supplied to the engine 70, so that the cooling amount of the engine 70, which is cooled by the coolant, can be adjusted.

Specifically, the high-temperature-side coolant circuit 20 has a function of a cooling system of the engine 70 and includes: the high-temperature-side radiator 23, which serves as the heat exchanger configured to release the heat from the coolant that is heated by the engine 70 at the time of operating the engine 70; and the third high-temperature circulation path CH3 configured to circulate the coolant between the engine 70 and the high-temperature-side radiator 23.

Next, the low-temperature-side coolant circuit 30 will be described. The low-temperature-side coolant circuit 30 is a cooling system that circulates the coolant, which is the low-temperature-side heat medium, mainly between: the battery 40, the inverter 41, the electric charger 42 and the motor generator 43; and the low-temperature-side radiator 33. The coolant, which is substantially the same as the high-temperature-side heat medium, can be used as the low-temperature-side heat medium.

The low-temperature-side coolant circuit 30 includes the coolant passage of the chiller 17, a first low-temperature-side heat medium pump 31a, a second low-temperature-side heat medium pump 31b, the low-temperature-side radiator 33, a first low-temperature-side flow rate regulating valve 34a, a second low-temperature-side flow rate regulating valve 34b and the heat storage device 100.

Furthermore, coolant passages of the electric devices, such as the battery 40, the inverter 41, the electric charger 42 and the motor generator 43, are connected to the low-temperature-side coolant circuit 30. These electric devices are heat generating devices, each of which generates heat at the time of operating it and thereby heat the coolant. Furthermore, these electric devices are respectively cooled by conducting the coolant through the coolant passage of the respective electric devices.

The battery 40 supplies the electric power to various electric devices installed in the vehicle. The battery 40 is a rechargeable secondary battery (a lithium ion battery in this embodiment). When the temperature is dropped to a low temperature, a chemical reaction becomes difficult to proceed in this type of battery 40. Thereby, the battery 40 cannot exhibit sufficient performance with respect to charge and discharge of the battery 40. In contrast, when the temperature is raised to a high temperature, deterioration of the battery 40 easily proceeds. Therefore, the temperature of the battery 40 needs to be adjusted within an appropriate temperature range (e.g., equal to or higher than 10 degrees Celsius and is equal to or lower than 40 degrees Celsius) that enables the battery 40 to perform the sufficient performance.

The inverter 41 is a power conversion device that converts a direct current into an alternating current. The electric charger 42 is an electric charger that charges the electric power to the battery 40. The motor generator 43 outputs a drive force for driving the vehicle when the electric power is supplied to the motor generator 43, and the motor generator 43 generates a regenerative electric power during deceleration of the vehicle or the like. Like in the case of the battery 40, the temperatures of these electric devices also need to be respectively adjusted within an appropriate temperature range that enables the respective electric devices to perform its sufficient performance.

The low-temperature-side coolant circuit 30 mainly has two circulation paths that circulate the coolant, i.e., a first low-temperature circulation path CL1 and a second low-temperature circulation path CL2. The first low-temperature circulation path CL1 and the second low-temperature circulation path CL2 have a low-temperature-side radiator flow passage 39, which is a common passage that is common to the first low-temperature circulation path CL1 and the second low-temperature circulation path CL2. Therefore, the coolant, which is circulated in the first low-temperature circulation path CL1, and the coolant, which is circulated in the second low-temperature circulation path CL2, are mixed in the low-temperature-side radiator flow passage 39.

Specifically, in the first low-temperature circulation path CL1, the coolant is circulated through mainly the first low-temperature-side heat medium pump 31a, the coolant passage of the chiller 17, the low-temperature-side reservoir tank 38, the heat storage device 100 and the low-temperature-side radiator 33 in this order.

In the second low-temperature circulation path CL2, the coolant is circulated through mainly the second low-temperature-side heat medium pump 31b, the coolant passage of the inverter 41, the coolant passage of the electric charger 42, the coolant passage of the motor generator 43, the heat storage device 100 and the low-temperature-side radiator 33 in this order.

The first low-temperature-side heat medium pump 31a, which pumps the coolant mainly in the first low-temperature circulation path CL1, is a coolant pump that pumps the coolant to an inlet of the coolant passage of the chiller 17. A basic structure of the first low-temperature-side heat medium pump 31a is substantially the same as that of the high-temperature-side heat medium pump 21.

A flow inlet 39a of the low-temperature-side radiator flow passage 39 is connected to the outlet of the coolant passage of the chiller 17 through the low-temperature-side reservoir tank 38. The heat storage device 100 and the low-temperature-side radiator 33 are arranged in this order from the upstream side toward the downstream side in the low-temperature-side radiator flow passage 39. The flow inlet 111g of the heat storage device 100 is connected to the flow inlet 39a of the low-temperature-side radiator flow passage 39. The flow outlet 111h of the heat storage device 100 is connected to a flow inlet of the low-temperature-side radiator 33.

The low-temperature-side reservoir tank 38 stores the coolant and absorbs a change in a volume of the coolant caused by thermal expansion and contraction of the coolant.

The flow rate regulator 150 is configured to reduce the first flow rate fr1 when the temperature of the coolant, which flows into the flow rate regulator 150, is decreased. Specifically, the flow rate regulator 150 reduces the flow rate of the coolant, which flows through the first flow passage F1, i.e., the flow rate of the coolant, which passes through the heat storage 112 when the temperature of the coolant, which flows into the low-temperature-side radiator flow passage 39, is decreased.

When the temperature of the coolant, which flows into the low-temperature-side radiator flow passage 39, becomes equal to or higher than the predetermined temperature, the flow rate regulator 150 opens the coolant passage, so that the coolant flows in the first flow passage F1 and passes through the flow passages 112a of the heat storage 112. Furthermore, when the temperature of the coolant is further increased, the flow rate regulator 150 increases the valve opening degree of the flow rate regulator 150 to increase the flow rate of the coolant that passes through the flow passages 112a of the heat storage 112.

The low-temperature-side radiator 33 is a heat exchanger that exchanges heat between the coolant, which is outputted from the heat storage device 100, and the outside air, which is blown by the outside-air fan (not shown).

In a state where the temperature of the coolant is higher than the temperature of the outside air, the low-temperature-side radiator 33 functions as a heat-releasing heat exchanger that releases the heat of the coolant to the outside air. Furthermore, in another state where the temperature of the coolant is lower than the temperature of the outside air, the low-temperature-side radiator 33 functions as a heat-absorbing heat exchanger that let the coolant to absorb the heat released from the outside air.

Furthermore, the first low-temperature circulation path CL1 has a first bypass passage 35a. The first bypass passage 35a is a passage that conducts the coolant outputted from the coolant passage of the chiller 17 to the suction inlet of the first low-temperature-side heat medium pump 31a while bypassing the heat storage device 100 and the low-temperature-side radiator 33.

The coolant passage of the battery 40 is connected to the first bypass passage 35a. In other words, the battery 40, which is a temperature regulating subject whose temperature is adjusted by the coolant flowing through the first bypass passage 35a, is installed in the first bypass passage 35a.

The first low-temperature-side flow rate regulating valve 34a is installed at an outlet of the first bypass passage 35a. A basic structure of the first low-temperature-side flow rate regulating valve 34a is substantially the same as that of the first high-temperature-side flow rate regulating valve 24. The first low-temperature-side flow rate regulating valve 34a is a flow rate regulating valve that adjusts the flow rate of the coolant flowing through the first bypass passage 35a in the low-temperature-side coolant circuit 30.

Therefore, in the low-temperature-side coolant circuit 30, the first low-temperature-side flow rate regulating valve 34a adjusts the flow rate of the coolant flowing through the first bypass passage 35a (i.e., the coolant passage of the battery 40), so that the temperature of the battery 40 is adjusted.

The second low-temperature-side heat medium pump 31b, which pumps the coolant mainly in the second low-temperature circulation path CL2, is a coolant pump that pumps the coolant to the coolant passage of the inverter 41. A basic structure of the second low-temperature-side heat medium pump 31b is substantially the same as that of the high-temperature-side heat medium pump 21. A coolant inlet of the low-temperature-side radiator 33 is connected to an outlet of the coolant passage of the motor generator 43.

Furthermore, the second low-temperature circulation path CL2 has a second bypass passage 35b. The second bypass passage 35b is a passage that conducts the coolant outputted from the coolant passage of the motor generator 43 to a suction inlet of the second low-temperature-side heat medium pump 31b while bypassing the heat storage device 100 and the low-temperature-side radiator 33.

The second low-temperature-side flow rate regulating valve 34b is installed at an inlet of the second bypass passage 35b. A basic structure of the second low-temperature-side flow rate regulating valve 34b is substantially the same as that of the first high-temperature-side flow rate regulating valve 24. The second low-temperature-side flow rate regulating valve 34b has a function of adjusting the flow rate of the coolant flowing through the second bypass passage 35b.

Therefore, in the low-temperature-side coolant circuit 30, the second low-temperature-side flow rate regulating valve 34b adjusts the flow rate of the coolant flowing through the second bypass passage 35b, so that the temperatures of the inverter 41, the electric charger 42 and the motor generator 43 are adjusted.

Specifically, the low-temperature-side coolant circuit 30 has a function of a cooling system of the electric devices and includes: the low-temperature-side radiator 33, which serves as the heat exchanger configured to release the heat from the coolant that is heated by the electric devices, such as the battery 40, the inverter 41, the electric charger 42 and the motor generator 43, at the time of operating these electric devices; and the first low-temperature circulation path CL1 and the second low-temperature circulation path CL2 configured to circulate the coolant between the above-described electric devices and the low-temperature-side radiator 33.

Next, the cabin air conditioning unit 50 will be described. In the refrigeration cycle apparatus 1, the cabin air conditioning unit 50 forms an air passage that is configured to discharge the blowing air, the temperature of which is adjusted by the refrigeration cycle 10, to an appropriate location in the vehicle cabin. The cabin air conditioning unit 50 is installed at an inside of an instrument panel located at a front part of the vehicle cabin.

The cabin air conditioning unit 50 includes a blower 52, the cabin evaporator 16 and the heater core 22, which are received in an air passage formed at the inside of the casing 51 that forms an outer shell of the cabin air conditioning unit 50.

The casing 51 forms the air passage, through which the blowing air to be blown into the vehicle cabin is conducted, and the casing 51 is molded from resin (specifically, polypropylene) having a certain degree of elasticity and excellent strength. An inside/outside air switching device 53 is placed at a most upstream part of the casing 51 in the flow direction of the blowing air. The air to be introduced into the inside of the casing 51 is switched between the inside air (the air at the inside of the vehicle cabin) and the outside air (the air at the outside of the vehicle cabin) by the inside/outside air switching device 53.

The inside/outside air switching device 53 is configured to operate an inside/outside air switching door to linearly adjust an opening cross-sectional area of an inside air inlet, through which the inside air is introduced into the casing 51, and an opening cross-sectional area of an outside air inlet, through which the outside air is introduced into the casing 51, to change a ratio between a flow rate of the inside air introduced into the casing 51 and a flow rate of the outside air introduced into the casing 51. The inside/outside air switching door is driven by an electric actuator for the inside/outside air switching door. An operation of this electric actuator is controlled by a control signal outputted from the control device 60.

The blower 52 is arranged on a downstream side of the inside/outside air switching device 53 in the flow direction of the blowing air. The blower 52 has a function of blowing the air, which is drawn through the inside/outside air switching device 53, toward the inside of the vehicle cabin. The blower 52 is an electric blower that drives a centrifugal multi-blade fan with an electric motor. A rotational speed (i.e., a blowing capacity) of the blower 52 is controlled by a control voltage outputted from the control device 60.

The cabin evaporator 16 and the heater core 22 are arranged one after another in this order in the flow direction of the blowing air at a location that is on the downstream side of the blower 52 in the flow direction of the blowing air. Specifically, the cabin evaporator 16 is arranged on the upstream side of the heater core 22 in the flow direction of the blowing air. A cool-air bypass passage 55 is formed at the inside of the casing 51 to conduct the blowing air, which has passed through the cabin evaporator 16, toward the downstream side while bypassing the heater core 22.

An air mix door 54 is arranged at a location that is on a downstream side of the cabin evaporator 16 in the flow direction of the blowing air and is on an upstream side of the heater core 22 in the flow direction of the blowing air. The air mix door 54 is configured to adjust a ratio between a flow rate of the blowing air to be passed through the heater core 22 after passing through the cabin evaporator 16 and a flow rate of the blowing air to be passed through the cool-air bypass passage 55 after passing through the cabin evaporator 16.

The air mix door 54 is driven by an electric actuator for the air mix door. An operation of this electric actuator is controlled by a control signal outputted from the control device 60.

A mixing space 56 is formed on the downstream side of the heater core 22 in the flow direction of the blowing air to mix the blowing air, which has been heated by the heater core 22, and the blowing air, which has passed through the cool-air bypass passage 55 and has not been heated by the heater core 22. Furthermore, an opening hole is formed at a most downstream part of the casing 51 in the flow direction of the blowing air to discharge the blowing air (conditioning air), which is mixed in the mixing space 56, into the vehicle cabin.

Therefore, the air mix door 54 adjusts the ratio between the flow rate of the air passed through the heater core 22 and the flow rate of the air passed through the cool-air bypass passage 55 to adjust the temperature of the conditioning air mixed in the mixing space 56. Thereby, the temperature of the blowing air (the conditioning air) blown from respective discharge outlets into the vehicle cabin is adjusted.

The control device 60 includes a microcomputer of a known type, which includes a CPU, a ROM and a RAM, and a peripheral circuit of the microcomputer. The control device 60 executes various calculations and processing based on an air-conditioning control program stored in the ROM and controls the various control subject devices 11, 14, 15, 21, 24, 25, 31a, 31b, 34a, 34b connected to the output side of the control device 60.

A group of control operation sensors (not shown) and the operating device 61 are connected to the input side of the control device 60. The operating device 61 is a device that is operated by a user to change settings of the refrigeration cycle apparatus 1. In the present embodiment, the operating device 61 is placed adjacent to the instrument panel located at the front part of the vehicle cabin. Operation signals, which are outputted from various air conditioning operation switches installed at the operating device 61, are inputted to the control device 60.

Next, the operation of the refrigeration cycle apparatus 1 of the present embodiment having the above described structure will be described. As described above, the refrigeration cycle apparatus 1 of the present embodiment has the function of air conditioning the vehicle cabin and the function of adjusting temperatures of the electric devices. Furthermore, the refrigeration cycle apparatus 1 is configured to switch the operation mode for the air conditioning operation of the vehicle cabin. The operation mode is switched by executing the air-conditioning control program stored in the control device 60 in advance.

This air-conditioning control program is executed when an air conditioning operation switch of the operating device 61 is turned on in a state where the vehicle system is running. According to the air-conditioning control program, the control device 60 computes a target discharge air temperature TAO of the blowing air to be blown into the vehicle cabin based on the measurement signals of the group of control operation sensors and the corresponding operation signal outputted from the operating device 61.

Furthermore, according to the air-conditioning control program, the control device 60 switches the operation mode based on the target discharge air temperature TAO, the measurement signals and the corresponding operation signal. Hereinafter, the operation of the respective operation modes will be described.

### (a) Cooling Mode

In the cooling mode, the control device 60 places the cooling expansion valve 14 in a flow restricting state to implement a refrigerant depressurizing action and also places the heat-absorbing expansion valve 15 in a full closing state.

In this way, in the refrigeration cycle 10 operated in the cooling mode, there is a vapor compression refrigeration cycle, in which the refrigerant is circulated through the compressor 11, the coolant-refrigerant heat exchanger 12, the branching portion 13a, the cooling expansion valve 14, the cabin evaporator 16, the evaporation pressure regulating valve 18, the merging portion 13b and the compressor 11 in this order. With this cycle configuration, the control device 60 controls the operations of the various control subject devices, which are connected to the output side of the control device 60.

Furthermore, the control device 60 operates the high-temperature-side heat medium pump 21 such that the high-temperature-side heat medium pump 21 implements a predetermined pumping capacity that is set for the cooling mode. Furthermore, the control device 60 determines a control signal, which is outputted to the first high-temperature-side flow rate regulating valve 24, such that all of the coolant flow, which is outputted from the coolant passage of the coolant-refrigerant heat exchanger 12, is supplied to the high-temperature-side radiator 23.

Furthermore, the control device 60 determines a control signal, which is outputted to the electric actuator for driving the air mix door 54, such that the air mix door 54 fully opens the cool-air bypass passage 55 and closes the heater core 22 side air passage. Furthermore, the control device 60 appropriately determines the control signals, which are outputted to the other control subject devices.

Therefore, in the refrigeration cycle 10, which is operated in the cooling mode, the high-pressure refrigerant, which is outputted from the compressor 11, is supplied to the coolant-refrigerant heat exchanger 12. In the coolant-refrigerant heat exchanger 12, since the high-temperature-side heat medium pump 21 is operated, heat exchange takes place between the high-pressure refrigerant and the coolant such that the high-pressure refrigerant is cooled and is condensed, and the coolant is heated.

In the high-temperature-side coolant circuit 20, the coolant, which is heated at the coolant-refrigerant heat exchanger 12, is supplied to the high-temperature-side radiator 23 through the first high-temperature-side flow rate regulating valve 24. The coolant, which is supplied to the high-temperature-side radiator 23, exchanges heat with the outside air and thereby releases the heat. Thereby, the coolant is cooled. The coolant, which is cooled at the high-temperature-side radiator 23, is suctioned into the high-temperature-side heat medium pump 21 and is pumped to the coolant passage of the coolant-refrigerant heat exchanger 12 once again.

The high-pressure refrigerant, which is cooled at the refrigerant passage of the coolant-refrigerant heat exchanger 12, is supplied to the cooling expansion valve 14 through the branching portion 13a and is depressurized. At this time, the opening degree of the flow-restricting opening of the cooling expansion valve 14 is adjusted such that a superheat degree of the refrigerant on the outlet side of the cabin evaporator 16 approaches a reference superheat degree.

The low-pressure refrigerant, which is depressurized at the cooling expansion valve 14, is supplied to the cabin evaporator 16. The refrigerant, which is supplied to the cabin evaporator 16, absorbs the heat from the blowing air discharged from the blower 52 and is evaporated. Thereby, the blowing air is cooled. The refrigerant, which is outputted from the cabin evaporator 16, is suctioned into the compressor 11 through the evaporation pressure regulating valve 18 and the merging portion 13b and is compressed once again.

Therefore, in the cooling mode, the vehicle cabin can be cooled by discharging the blowing air, which is cooled by the cabin evaporator 16, into the vehicle cabin.

Here, the cooling mode is the operation mode that is executed in a state where the outside air temperature Tam is relatively high (e.g., a state where the outside air temperature is equal to or higher than 25 degrees Celsius). Therefore, the temperatures of the battery 40, the inverter 41, the electric charger 42 and the motor generator 43 may possibly rise above the appropriate temperature range due to self-heating.

In view of the above point, the control device 60 operates the first low-temperature-side heat medium pump 31a such that the first low-temperature-side heat medium pump 31a implements a predetermined pumping capacity when the temperature T40 of the battery 40, which is sensed with a battery temperature sensor (not shown), is equal to or higher than a predetermined reference battery temperature. Furthermore, the control device 60 controls the operation of the first low-temperature-side flow rate regulating valve 34a such that the temperature T40 of the battery 40 is maintained within the appropriate temperature range.

Similarly, the control device 60 operates the second low-temperature-side heat medium pump 31b such that the second low-temperature-side heat medium pump 31b implements a predetermined pumping capacity when any one of the temperature T41 of the inverter 41, which is sensed with an inverter temperature sensor (not shown), the temperature T42 of the electric charger 42, which is sensed with an electric charger temperature sensor (not shown), and the temperature T43 of the motor generator 43, which is sensed with a motor generator temperature sensor (not shown), is equal to or higher than a predetermined corresponding reference temperature.

Furthermore, the control device 60 controls the operation of the second low-temperature-side flow rate regulating valve 34b such that each of the temperature T41 of the inverter 41, the temperature T42 of the electric charger 42 and the temperature T43 of the motor generator 43 is maintained within an appropriate corresponding temperature range.

When the temperature of the coolant, which is supplied to the low-temperature-side radiator flow passage 39, becomes equal to or higher than a predetermined temperature due to an increase in the temperature of the coolant, which flows in the low-temperature-side coolant circuit 30, caused by the heat generation of the battery 40, the inverter 41, the electric charger 42 and/or the motor generator 43, the flow rate regulator 150 is opened to supply the coolant to the heat storage device 100. Therefore, the heat released from the coolant is stored in the heat storage 112. Furthermore, when the temperature of the coolant, which is supplied to the low-temperature-side radiator flow passage 39, is increased, the flow rate of the coolant, which is supplied to the heat storage device 100, is increased by the flow rate regulator 150.

The temperature adjustment of the electric devices by the control device 60 described above is not necessarily limited to the cooling mode and is also executed in the dehumidifying and heating mode and the heating mode depending on a need. Furthermore, as long as the entire vehicle system is running, the temperature adjustment of the electric devices by the control device 60 is executed depending on a need regardless of whether the vehicle cabin is air-conditioned or not (i.e., regardless of whether the air-conditioning control program is executed or not).

### (b) Dehumidifying and Heating Mode

In the dehumidifying and heating mode, the control device 60 places the cooling expansion valve 14 in a flow restricting state and places the heat-absorbing expansion valve 15 in a flow restricting state.

In this way, in the refrigeration cycle 10 operated in the dehumidifying and heating mode, there is the vapor compression refrigeration cycle, in which the refrigerant is circulated through the compressor 11, the coolant-refrigerant heat exchanger 12, the branching portion 13a, the cooling expansion valve 14, the cabin evaporator 16, the evaporation pressure regulating valve 18, the merging portion 13b and the compressor 11 in this order, and the refrigerant is circulated through the compressor 11, the coolant-refrigerant heat exchanger 12, the branching portion 13a, the heat-absorbing expansion valve 15, the chiller 17, the merging portion 13b and the compressor 11 in this order.

Specifically, in the dehumidifying and heating mode, the refrigerant circuit is switched to the refrigerant circuit, in which the cabin evaporator 16 and the chiller 17 are connected in parallel. With this cycle configuration, the control device 60 controls the operations of the various control subject devices, which are connected to the output side of the control device 60.

Furthermore, the control device 60 operates the high-temperature-side heat medium pump 21 such that the high-temperature-side heat medium pump 21 implements a predetermined pumping capacity that is set for the dehumidifying and heating mode. Furthermore, the control device 60 determines the control signal, which is outputted to the first high-temperature-side flow rate regulating valve 24, such that all of the coolant flow, which is outputted from the coolant passage of the coolant-refrigerant heat exchanger 12, is supplied to the heater core 22.

Furthermore, the control device 60 determines the control signal, which is outputted to the electric actuator for driving the air mix door 54, such that the air mix door 54 fully opens the heater core 22 side air passage and closes the cool-air bypass passage 55. Furthermore, the control device 60 appropriately determines the control signals, which are outputted to the other control subject devices.

Therefore, in the refrigeration cycle 10, which is operated in the dehumidifying and heating mode, the high-pressure refrigerant, which is outputted from the compressor 11, is supplied to the coolant-refrigerant heat exchanger 12. In the coolant-refrigerant heat exchanger 12, since the high-temperature-side heat medium pump 21 is operated, heat exchange takes place between the high-pressure refrigerant and the coolant such that the high-pressure refrigerant is cooled and is condensed, and the coolant is heated.

In the high-temperature-side coolant circuit 20, the coolant, which is heated at the coolant-refrigerant heat exchanger 12, is supplied to the heater core 22 through the first high-temperature-side flow rate regulating valve 24. Since the air mix door 54 fully opens the heater core 22 side air passage, the coolant, which is supplied to the heater core 22, exchanges heat with the blowing air passed through the cabin evaporator 16. Thereby, the blowing air passed through the cabin evaporator 16 is heated, and thereby the temperature of the blowing air approaches the target discharge air temperature TAO.

The coolant, which is outputted from the heater core 22, is suctioned into the high-temperature-side heat medium pump 21 and is pumped to the coolant passage of the coolant-refrigerant heat exchanger 12 once again.

The high-pressure refrigerant, which is outputted from the refrigerant passage of the coolant-refrigerant heat exchanger 12, is branched at the branching portion 13a. One of two branched refrigerant flows, which are branched at the branching portion 13a, is supplied to the cooling expansion valve 14 and is depressurized. The low-pressure refrigerant, which is depressurized at the cooling expansion valve 14, is supplied to the cabin evaporator 16. The refrigerant, which is supplied to the cabin evaporator 16, absorbs the heat from the blowing air discharged from the blower 52 and is evaporated. Thereby, the blowing air is cooled and is dehumidified.

At this time, the refrigerant evaporation temperature at the cabin evaporator 16 is maintained at 1 degrees Celsius or higher by the action of the evaporation pressure regulating valve 18 regardless of the refrigerant discharge capacity of the compressor 11. Therefore, no frost is formed on the cabin evaporator 16. The refrigerant, which is outputted from the cabin evaporator 16, is supplied to the one of the refrigerant inlet openings of the merging portion 13b through the evaporation pressure regulating valve 18.

The other one of the branched refrigerant flows, which are branched at the branching portion 13a, is supplied to the heat-absorbing expansion valve 15 and is depressurized. At this time, an opening degree of a flow-restricting opening of the heat-absorbing expansion valve 15 is adjusted such that the refrigerant evaporation temperature at the chiller 17 becomes lower than at least the outside air temperature Tam. The low-pressure refrigerant, which is depressurized at the heat-absorbing expansion valve 15, is supplied to the chiller 17. The refrigerant, which is supplied to the chiller 17, absorbs the heat from the coolant and is evaporated.

The refrigerant, which is outputted from the chiller 17, is supplied to the other one of the refrigerant inlet openings of the merging portion 13b and is merged with the refrigerant outputted from the evaporation pressure regulating valve 18. The refrigerant, which is outputted from the merging portion 13b, is suctioned into the compressor 11 and is compressed once again.

Therefore, in the dehumidifying and heating mode, the vehicle cabin can be dehumidified and heated by discharging the blowing air, which is first cooled and dehumidified at the cabin evaporator 16 and is thereafter reheated by the heater core 22, into the vehicle cabin.

### (c) Heating Mode

In the heating mode, the control device 60 places the cooling expansion valve 14 in a full closing state and places the heat-absorbing expansion valve 15 in the flow restricting state.

In this way, in the refrigeration cycle 10 operated in the heating mode, there is a vapor compression refrigeration cycle, in which the refrigerant is circulated through the compressor 11, the coolant-refrigerant heat exchanger 12, the branching portion 13a, the heat-absorbing expansion valve 15, the chiller 17, the merging portion 13b and the compressor 11 in this order. With this cycle configuration, the control device 60 controls the operations of the various control subject devices, which are connected to the output side of the control device 60.

Furthermore, the control device 60 operates the high-temperature-side heat medium pump 21 such that the high-temperature-side heat medium pump 21 implements a predetermined pumping capacity that is set for the heating mode. Furthermore, like in the dehumidifying and heating mode, the control device 60 determines the control signal, which is outputted to the first high-temperature-side flow rate regulating valve 24, such that all of the coolant flow, which is outputted from the coolant passage of the coolant-refrigerant heat exchanger 12, is supplied to the heater core 22.

Like in the dehumidifying and heating mode, the control device 60 determines the control signal, which is outputted to the electric actuator for driving the air mix door 54, such that the air mix door 54 fully opens the heater core 22 side air passage and closes the cool-air bypass passage 55. Furthermore, the control device 60 appropriately determines the control signals, which are outputted to the other control subject devices.

Therefore, in the refrigeration cycle 10, which is operated in the heating mode, the high-pressure refrigerant, which is outputted from the compressor 11, is supplied to the coolant-refrigerant heat exchanger 12. In the coolant-refrigerant heat exchanger 12, since the high-temperature-side heat medium pump 21 is operated, heat exchange takes place between the high-pressure refrigerant and the coolant such that the high-pressure refrigerant is cooled and is condensed, and the coolant is heated.

In the high-temperature-side coolant circuit 20, the coolant, which is heated at the coolant-refrigerant heat exchanger 12, is supplied to the heater core 22 through the first high-temperature-side flow rate regulating valve 24. Since the air mix door 54 fully opens the heater core 22 side air passage, the coolant, which is supplied to the heater core 22, exchanges heat with the blowing air passed through the cabin evaporator 16. Thereby, the blowing air is heated, and thereby the temperature of the blowing air approaches the target discharge air temperature TAO.

The coolant, which is outputted from the heater core 22, is suctioned into the high-temperature-side heat medium pump 21 and is pumped to the coolant passage of the coolant-refrigerant heat exchanger 12 once again.

The high-pressure refrigerant, which is outputted from the refrigerant passage of the coolant-refrigerant heat exchanger 12, is supplied to the heat-absorbing expansion valve 15 through the branching portion 13a and is depressurized. At this time, the opening degree of the flow-restricting opening of the heat-absorbing expansion valve 15 is adjusted such that the refrigerant evaporation temperature at the chiller 17 becomes lower than the outside air temperature Tam. The low-pressure refrigerant, which is depressurized at the heat-absorbing expansion valve 15, is supplied to the chiller 17. Like in the dehumidifying and heating mode, the refrigerant, which is supplied to the chiller 17, absorbs the heat from the coolant and is evaporated.

In the low-temperature-side coolant circuit 30, like in the dehumidifying and heating mode, the coolant, which is cooled at the chiller 17, is supplied to the heat storage device 100. The coolant, which is outputted from the heat storage device 100, is supplied to the low-temperature-side radiator 33. The coolant, which is outputted from the low-temperature-side radiator 33, is suctioned into the first low-temperature-side heat medium pump 31a and is pumped toward the coolant passage of the chiller 17.

Here, the heating mode is the operation mode that is executed in a state where the outside air temperature Tam is relatively low (e.g., a state where the outside air temperature is equal to or lower than 10 degrees Celsius). Therefore, the temperature of the coolant supplied to the heat storage device 100 is often lower than a stored heat temperature (a temperature of the stored heat) of the heat storage 112, and thereby the heat stored in the heat storage 112 is often released to the coolant.

Furthermore, in the heating mode, the temperature of the coolant supplied to the low-temperature-side radiator 33 is often lower than the outside air temperature Tam, and the coolant at the low-temperature-side radiator 33 often absorbs the heat from the outside air. Therefore, even in the heating mode, the temperature of the coolant outputted from the low-temperature-side radiator 33 approaches the outside air temperature Tam and can become higher than the temperature of the refrigerant supplied to the chiller 17.

Therefore, even in the heating mode, like in the dehumidifying and heating mode, the refrigerant, which is supplied to the chiller 17, can reliably absorb the heat from the coolant. Furthermore, in the refrigeration cycle 10, the heat, which is absorbed by the refrigerant at the chiller 17, can be used as a heat source for heating the blowing air.

The refrigerant, which is outputted from the chiller 17, is suctioned into the compressor 11 through the merging portion 13b and is compressed once again.

Therefore, in the heating mode, the vehicle cabin can be heated by discharging the blowing air, which is heated by the heater core 22, into the vehicle cabin.

As discussed above, the refrigeration cycle apparatus 1 of the present embodiment can switch the operation mode among the cooling mode, the dehumidifying and heating mode and the heating mode by switching the refrigerant circuit at the refrigeration cycle 10, so that comfortable air conditioning of the vehicle cabin can be achieved.

Here, it should be noted that the refrigeration cycle 10, in which the refrigerant circuit is switched according to the operation mode like in the present embodiment, will likely result in complication of the cycle configuration.

In contrast, in refrigeration cycle 10 of the present embodiment, switching does not take place between the refrigerant circuit, which supplies the high-pressure refrigerant to a common heat exchanger, and the refrigerant circuit, which supplies the low-pressure refrigerant to the common heat exchanger. Specifically, regardless of which one of the two refrigerant circuits is switched, it is not required to supply the high-pressure refrigerant to the cabin evaporator 16 and the chiller 17, so that the refrigerant circuit can be switched with the simple configuration without resulting in complication of the cycle configuration.

Furthermore, the refrigeration cycle apparatus 1 of the present embodiment includes the low-temperature-side coolant circuit 30, which is the cooling system, so that the heat, which is generated from the battery 40, the inverter 41, the electric charger 42 and the motor generator 43, can be released to the outside air at the low-temperature-side radiator 33 (serving as the heat exchanger) to maintain the respective temperatures of the battery 40, the inverter 41, the electric charger 42 and the motor generator 43 in a corresponding appropriate temperature range.

However, for example, when the battery 40 is rapidly charged, the amount of heat generated by the battery 40 is increased in comparison to the normal operation time. Thus, in such a case, it would happen that the heat releasing capacity of the low-temperature-side radiator 33 becomes insufficient, and thereby the temperature increase of the battery 40 cannot be limited.

In contrast, the low-temperature-side coolant circuit 30 of the present embodiment has the heat storage device 100. Therefore, for example, when the amount of heat generated from the battery 40 is increased, the heat, which cannot be released at the low-temperature-side radiator 33, can be stored in the heat storage device 100. Therefore, it is possible to limit an increase in the temperature of the battery 40.

Furthermore, the flow rate regulator 150 of the present embodiment reduces the first flow rate fr1 when the temperature of the coolant flowing in the low-temperature-side coolant circuit 30 is decreased. Thus, when the temperature of the coolant flowing in the low-temperature-side coolant circuit 30 is decreased, the first flow rate fr1 is reduced, and thereby the flow rate of the coolant supplied to the heat storage 112 is reduced.

Therefore, it is possible to limit the unnecessary heat storage at the heat storage 112 in the state where the heat releasing capacity of the low-temperature-side radiator 33 has not become insufficient, and the temperature of the coolant flowing in the low-temperature-side coolant circuit 30 is low, and thereby it is not necessary to absorb the heat from the coolant at the heat storage 112.

Thus, the heat storage 112 can sufficiently absorb the heat from the coolant when the heat storage 112 needs to absorb the heat from the coolant due to the increase in the temperature of the coolant flowing in the low-temperature-side coolant circuit 30 in the state where the heat releasing capacity of the low-temperature-side radiator 33 is insufficient. As a result, it is possible to provide the heat storage device 100 that can limit the rapid temperature increase of the coolant.

Furthermore, the first flow passage F1 and the second flow passage F2 of the present embodiment are located at the inside of the container 111. Therefore, it is not required to form the second flow passage F2 at the outside of the container 111, and thereby it is possible to limit an increase in a size of the low-temperature-side coolant circuit 30. As a result, it is possible to limit an increase in a size of the entire refrigeration cycle apparatus 1.

Furthermore, the flow rate regulator 150 of the present embodiment is located on the upstream side of the heat storage 112. Accordingly, in a case where the temperature of the coolant is low, the flow rate of the coolant supplied to the heat storage 112 is reduced by the flow rate regulator 150 before the time of supplying the coolant of the low temperature to the heat storage 112. Thus, in the case where the temperature of the coolant is low, the wasteful absorption of the heat from the coolant at the heat storage 112 is further limited.

Furthermore, in the present embodiment, the thermostatic valve is used as the flow rate regulator 150. The thermostatic valve reduces the first flow rate fr1 when the temperature of the coolant flowing in the thermostatic valve is decreased. Therefore, in comparison to a case where an electric flow rate regulating valve is used as the flow rate regulator 150, a sensor, which senses the temperature of the coolant, as well as electric components, electronic components and a software for operating the flow rate regulating valve are not required. Thus, it is possible to provide the heat storage device 100, which can adjust the amount of stored heat that is stored in the heat storage device 100, without resulting in complication of the configuration of the refrigeration cycle apparatus 1.

Furthermore, the heat storage 112 of the present embodiment is in the solid state in the assumed temperature range of the coolant. Therefore, even when a change in the circulation flow rate of the coolant occurs, the heat storage 112 is not deformed and is not moved.

Thus, it is possible to limit a change in the heat transfer performance for transferring the heat between the coolant and the heat storage 112. As a result, in a case where the heat releasing capacity of the low-temperature-side radiator 33 becomes insufficient, it is possible to store a desired amount of heat in the heat storage 112 as necessary depending on a need.

Furthermore, in the present embodiment, the latent heat storage material, which undergoes the phase change at the time of storing the heat, is fixed by the skeletal material and the capsules made of the sensible heat storage material, which does not undergo the phase change at the time of storing the heat, to implement the heat storage 112. Therefore, the heat storage 112, which is in the solid state within the assumed temperature range of the coolant, can be easily formed.

Furthermore, since the heat storage 112 of the present embodiment includes the latent heat storage material, it is possible to realize efficient heat storage in comparison to a case where the entire heat storage unit 112 is made of the sensible heat storage material, and the size of the entire heat storage device 100 can be made compact. Thus, it is possible to limit an increase in the size of the low-temperature-side coolant circuit 30. Thereby, it is possible to limit an increase in a size of the entire refrigeration cycle apparatus 1.

Furthermore, in the heat storage 112 of the present embodiment, the flow passages 112a, which conduct the coolant, are arranged parallel to each other. Thereby, a contact surface area between the coolant and the heat storage 112 can be increased to implement further efficient heat storage. Thus, it is possible to limit the rapid temperature increase of the coolant.

Furthermore, since the heat storage device 100 of the present embodiment includes the container 111, it is possible to form the space 111a, which can receive the heat storage 112 having the heat capacity capable of storing the desired amount of heat. Furthermore, the heat storage 112 can be formed into a desired shape (i.e., a shape that matches the shape of a portion at which the heat storage 112 is fixed) by injection molding. Thus, the heat storage 112 can be easily formed into a shape that can be immovably fixed in the space 111a of the container 111.

### Second Embodiment

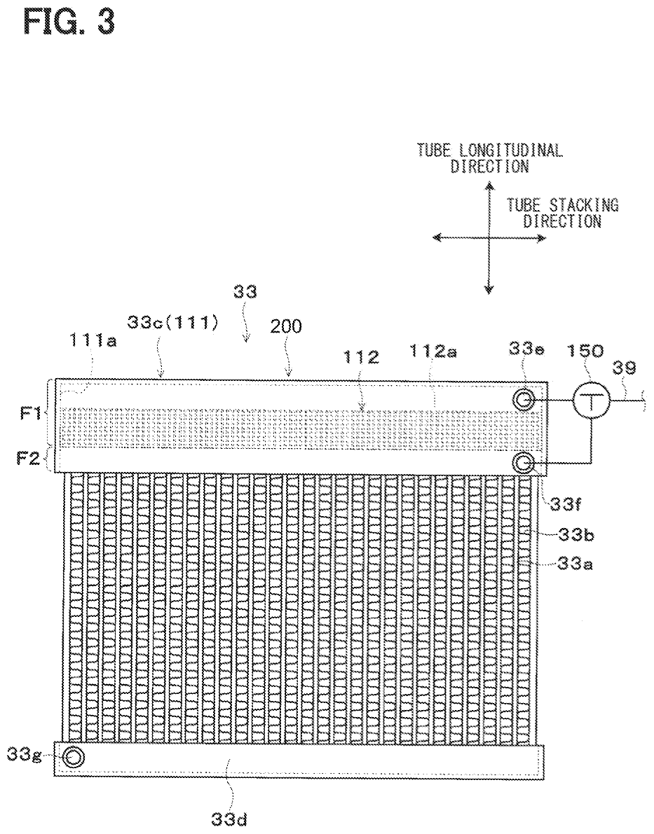

A heat storage device 200 of a second embodiment will be described with reference to FIG. 3. As shown in FIG. 3, in the heat storage device 200 of the second embodiment, an inflow-side tank 33c of the low-temperature-side radiator 33 serves as the container 111, and the heat storage 112 is received in the inflow-side tank 33c. In other words, the heat storage device 200 is integrated in the low-temperature-side radiator 33.

The low-temperature-side radiator 33 is formed as a so-called tank-and-tube type heat exchanger and includes a plurality of tubes 33a, a plurality of fins 33b, the inflow-side tank 33c, an outflow-side tank 33d and the heat storage 112. The tubes 33a, the fins 33b, the inflow-side tank 33c and the outflow-side tank 33d are all made of the same kind of metal (for example, aluminum alloy) having excellent heat conductivity and are brazed together.

Each of the tubes 33a is a tube through which the coolant flows. A cross section of each tube 33a is shaped in a flat oval form (i.e., a flat form) such that a flow direction of the air flowing through the low-temperature-side reservoir tank 38 coincides with a longitudinal direction of the cross section of the tube 33a. The tubes 33a are arranged in parallel with each other and are spaced from each other in a horizontal direction such that a longitudinal direction of each tube 33a coincide with a vertical direction.

In the following description, as shown in FIG. 3, the longitudinal direction of the respective tubes 33a will be referred to as a tube longitudinal direction (a top-to-bottom direction in FIG. 3), and a direction, in which the tubes 33a are stacked, will be referred to as a tube stacking direction (a left-to-right direction in FIG. 3).

The fins 33b are heat transfer members and are corrugated fins respectively shaped in a wave form. The fins 33b are joined to two opposite flat surfaces of the tubes 33a. Each fin 33b is configured to increase the heat transfer surface area between the fin 33b and the air to promote heat exchange between the coolant and the air.

The inflow-side tank 33c and the outflow-side tank 33d are opposed to each other. The tubes 33a are joined between the inflow-side tank 33c and the outflow-side tank 33d.

The inflow-side tank 33c is configured to distribute the coolant to the tubes 33a. The outflow-side tank 33d is configured to collect the coolant outputted from the tubes 33a. The inflow-side tank 33c and the outflow-side tank 33d are respectively located at and are communicated with two opposite ends of the respective tubes 33a in the tube longitudinal direction while the inflow-side tank 33c and the outflow-side tank 33d extend in the tube stacking direction.

As shown in FIG. 3, the receiving space 111a located in the inflow-side tank 33c have a first flow passage F1, which is located on a side that is spaced away from the tubes 33a, and a second flow passage F2, which is located on a side where the tubes 33a are placed. The second flow passage F2 is located adjacent to connections, at each of which a corresponding one of the tubes 33a is connected to the inflow-side tank 33c.

The heat storage 112 is shaped in a block form, a longitudinal direction of which coincides with the tube stacking direction. The heat storage 112 is arranged at the tube 33a side of the first flow passage F1. An outer peripheral surface of the heat storage 112 is shaped in a form that corresponds to an inner peripheral surface of the receiving space 111a in the inflow-side tank 33c, and the outer peripheral surface of the heat storage 112 is in close contact with the inner peripheral surface of the receiving space 111a in the inflow-side tank 33c. With the above described configuration, the heat storage 112 is immovably fixed to the inflow-side tank 33c.

The flow passages 112a extend in the tube longitudinal direction and are arranged in parallel in the tube stacking direction. The flow passages 112a are communicated with the second flow passage F2.

The inflow-side tank 33c has a first flow inlet 33e that is communicated with the first flow passage F1. The inflow-side tank 33c also has a second flow inlet 33f that is communicated with the second flow passage F2. The outflow-side tank 33d has a flow outlet 33g that is communicated with a space in the outflow-side tank 33d.

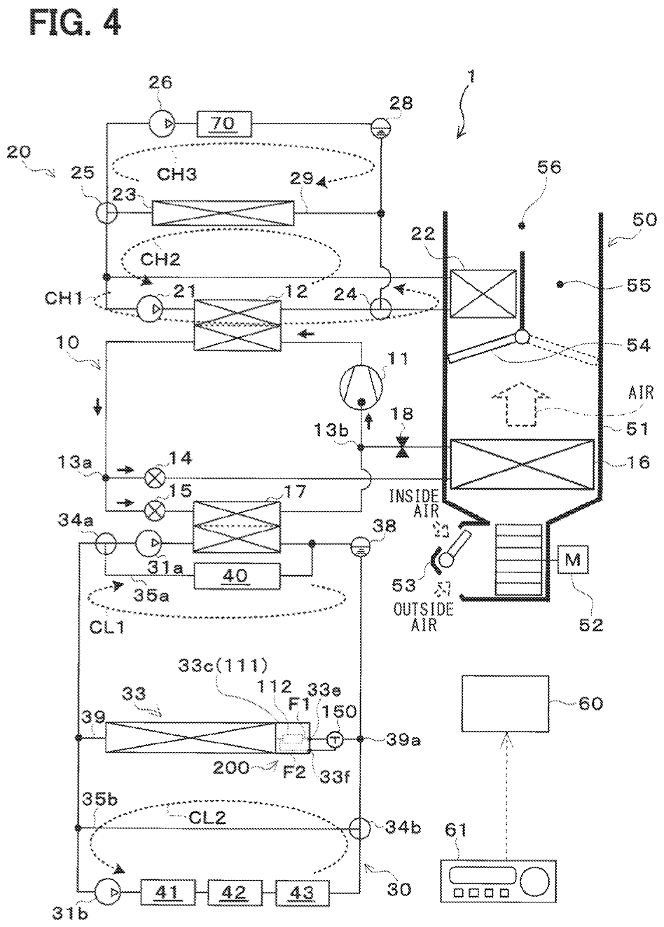

As shown in FIG. 4, in the refrigeration cycle apparatus 1 that has the heat storage device 200 of the second embodiment, the flow rate regulator 150 and the low-temperature-side radiator 33 are arranged one after another from the upstream side toward the downstream side in the low-temperature-side radiator flow passage 39.

The flow rate regulator 150 has one flow inlet and two flow outlets. The flow inlet of the flow rate regulator 150 is connected to the flow inlet 39a of the low-temperature-side radiator flow passage 39. One of the two flow outlets of the flow rate regulator 150 is connected to the first flow inlet 33e of the low-temperature-side radiator 33. The other one of the flow outlets of the flow rate regulator 150 is connected to the second flow inlet 33f of the low-temperature-side radiator 33.

The flow outlet 33g of the low-temperature-side radiator 33 is connected to a flow inlet of the first low-temperature-side flow rate regulating valve 34a and the suction inlet of the second low-temperature-side heat medium pump 31b.

The flow rate regulator 150 adjusts a flow rate ratio that is a ratio between a first flow rate fr1 of the coolant, which is supplied from the first flow inlet 33e and flows in the first flow passage F1, and a second flow rate fr2 of the coolant, which is supplied from the second flow inlet 33f into the second flow passage F2 and flows in the second flow passage F2. Specifically, the flow rate regulator 150 is configured to reduce the first flow rate fr1 when the temperature of the coolant, which flows into the flow rate regulator 150, is decreased. Specifically, the flow rate regulator 150 reduces the flow rate of the coolant, which flows in the flow passages 112a of the heat storage 112, when the temperature of the coolant, which flows into the low-temperature-side radiator flow passage 39, is decreased.

Other structure and operations of the refrigeration cycle apparatus 1 are the same as those of the first embodiment. Therefore, even when the heat storage device 200 of the present embodiment is used, advantages, which are the same as those of the first embodiment, can be achieved.

More specifically, the flow rate regulator 150 reduces the first flow rate fr1 when the temperature of the coolant, which flows into the low-temperature-side radiator flow passage 39, is decreased. Thus, when the temperature of the coolant is decreased, the first flow rate fr1 is reduced, and thereby the flow rate of the coolant supplied to the heat storage 112 is reduced. Therefore, it is possible to limit the unnecessary heat storage at the heat storage device 100 in the state where the heat releasing capacity of the low-temperature-side radiator 33 has not become insufficient, and the temperature of the coolant flowing in the low-temperature-side coolant circuit 30 is low, and thereby it is not necessary to absorb the heat from the coolant at the heat storage 112.

Thus, the heat storage 112 can sufficiently absorb the heat from the coolant when the heat storage 112 needs to absorb the heat from the coolant due to the increase in the temperature of the coolant flowing in the low-temperature-side coolant circuit 30 in the state where the heat releasing capacity of the low-temperature-side radiator 33 is insufficient. Thus, it is possible to limit the rapid temperature increase of the coolant.

In the heat storage device 200 of the second embodiment, the inflow-side tank 33c of the low-temperature-side radiator 33 serves as the container 111, and the heat storage 112 is received in the inflow-side tank 33c of the low-temperature-side radiator 33. Therefore, it is not required to provide the heat storage device 200 separately from the low-temperature-side radiator 33, and thereby it is possible to limit an increase in a size of the low-temperature-side coolant circuit 30. Thereby, it is possible to limit an increase in a size of the entire refrigeration cycle apparatus 1.

The heat storage 112 is in the solid state in the assumed temperature range of the coolant, and the heat storage 112 is immovably fixed to the inflow-side tank 33c. Therefore, even when the coolant flows in the inflow-side tank 33c, the heat storage 112 is not deformed and is not moved in the inflow-side tank 33c. Thus, it is possible to limit a change in the heat transfer performance for transferring the heat between the coolant and the heat storage 112.

The heat storage 112 is shaped in the block form, the longitudinal direction of which coincides with the tube stacking direction, and the flow passages 112a extend in the tube longitudinal direction and are arranged in parallel in the tube stacking direction. Thereby, even though a length of the respective flow passages 112a is reduced in comparison to a length of the heat storage 112 measured in the longitudinal direction of the heat storage 112, a required contact surface area between the coolant and the heat storage 112 can be ensured. Thus, it is possible to reduce the pressure loss at the time of conducting the coolant through the flow passages 112a while maintaining the heat absorption performance of the heat storage 112. As a result, the electric power consumption for driving the first low-temperature-side heat medium pump 31a and the second low-temperature-side heat medium pump 31b can be reduced.

The heat storage 112 is formed such that the large number of fine spherical heat storage material pieces are dispersed over and molded together with the skeletal material that is made of the synthetic resin (e.g., polypropylene) having the excellent heat resistance. Therefore, the heat storage 112 can be easily formed into an arbitrary shape, and thus the heat storage 112 can be molded into a shape corresponding to the inflow-side tank 33c.

Therefore, the heat storage 112 can be received in the preexisting inflow-side tank 33c without requiring a change in the shape of the inflow-side tank 33c to receive the heat storage 112 in the inflow-side tank 33c. Therefore, it is possible to limit an increase in the costs, which would be caused by addition of the heat storage device 200 to the refrigeration cycle apparatus 1.

In the above description, there is described the heat storage device 200 that has the inflow-side tank 33c of the low-temperature-side radiator 33 as the container 111. However, it should be noted that the second embodiment is also about the heat exchanger (specifically, the low-temperature-side radiator 33) that includes:

a plurality of tubes 33a that are respectively configured to conduct coolant;

a tank 33c, 33d that is configured to distribute the coolant into the plurality of tubes 33a or collect the coolant from the plurality of tubes 33a; and

a heat storage 112, which is configured to store heat released from the coolant, wherein:

a first flow passage F1, in which the heat storage 112 is installed, and a second flow passage F2, which is configured to conduct the coolant and bypass the heat storage 112, are formed at an inside of the tank 33c;

the heat exchanger further includes a flow rate regulator 150 that is configured to adjust a flow rate ratio that is a ratio of a second flow rate fr2 of the coolant, which flows in the second flow passage F2, relative to a first flow rate fr1 of the coolant, which flows in the first flow passage F1, and

the flow rate regulator 150 is configured to reduce the first flow rate fr1 when a temperature of the coolant is decreased.

### Other Embodiments

In the above embodiments, there is described the example where the refrigeration cycle apparatus 1 is applied to the plug-in hybrid vehicle. However, the application of the refrigeration cycle apparatus 1 is not necessarily limited to this. For example, the refrigeration cycle apparatus 1 may be applied to an ordinary hybrid vehicle or an electric vehicle that is driven by a drive force of only the motor generator 43. In such a case, the high-temperature-side coolant circuit 20 may be eliminated. Alternatively, the refrigeration cycle apparatus 1 may be applied to an ordinary vehicle that obtains a drive force for driving the vehicle from an internal combustion engine. In such a case, the low-temperature-side coolant circuit 30 may be eliminated, and the heat storage device of the present disclosure may be installed in the high-temperature-side coolant circuit 20.

Furthermore, in the heat storage device 100 of the first embodiment, there is described the example where the flow rate regulator 150 is located on the upstream side of the heat storage 112. Alternatively, the flow rate regulator 150 may be placed on the downstream side of the heat storage 112. In the above embodiment, the second flow passage F2 and the flow rate regulator 150 are placed at the inside of the container 111. The second flow passage F2 and the flow rate regulator 150 may be placed at the outside of the container 111.

The location of the heat storage device 100 should not be limited to the location discussed in the above embodiment, and the heat storage device 100 may be placed another location at the low-temperature-side coolant circuit 30. Furthermore, the heat storage device 100 may be placed at the high-temperature-side coolant circuit 20. With this configuration, it is possible to limit a rapid temperature increase of the coolant that flows in the high-temperature-side coolant circuit 20.

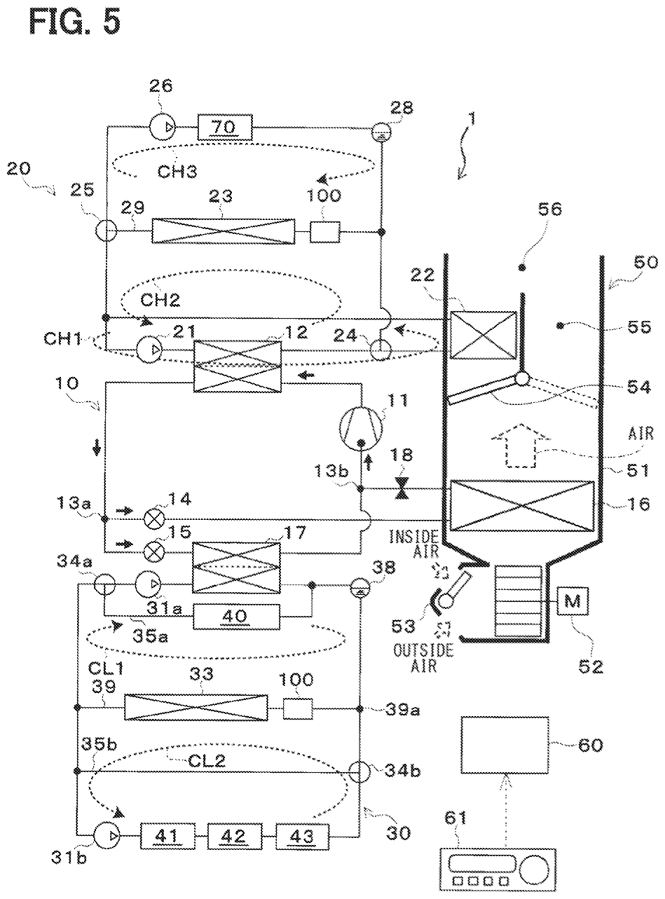

For example, as shown in FIG. 5, the heat storage device 100 may be installed in the high-temperature-side radiator flow passage 29 at a location that is on the upstream side of the high-temperature-side radiator 23. Similarly, the heat storage device 100 may be installed in the high-temperature-side coolant circuit 20 at a location, which is on the downstream side of the high-temperature-side radiator 23, or a location, which is on the upstream side or the downstream side of one of the engine 70, the engine coolant pump 26, the high-temperature-side heat medium pump 21 and the coolant-refrigerant heat exchanger 12. Of course, like in the fourth embodiment, the heat storage device 200 may be integrated in the high-temperature-side radiator 23.

As discussed above, in the case where the heat storage device 100, 200 is applied to the high-temperature-side coolant circuit 20, a material, which is in a solid state in an assumed temperature range (specifically, −5 degrees Celsius to 110 degrees Celsius) of the coolant that flows in the high-temperature-side coolant circuit 20, may be selected as the skeletal material and the material of the capsules.

Furthermore, in the heat storage device 200 of the second embodiment, the heat storage 112 is received in the inflow-side tank 33c of the low-temperature-side radiator 33. Alternatively or additionally, the heat storage device 200 may be configured such that the heat storage 112 is received in the outflow-side tank 33d of the low-temperature-side radiator 33. In the case where the heat storage 112 is received in each of the inflow-side tank 33c and the outflow-side tank 33d of the low-temperature-side radiator 33, it is possible to increase the amount heat that can be absorbed at the heat storage device 200.

Furthermore, in the above embodiments, there is described the example that uses the heat storage 112, which includes the latent heat storage material that undergo the phase change at the time of storing the heat. However, the heat storage 112 is not necessarily limited to this. For example, the heat storage 112 may be configured to include a chemical heat storage material that causes a chemical change thereof at the time of storing the heat.

Furthermore, the heat storage 112 may be configured to include a strongly correlated material (SCM) that undergoes a chemical change in response to a change in the temperature and stores latent heat. As such a strongly correlated material, a mixture of vanadium oxide and a doping agent (so-called composite agent) may be used. As the doping agent, it is desirable to use a phase change temperature control agent, such as tungsten or chromium. The heat storage 112, which includes the strongly correlated material, may be manufactured by, for example, sintering vanadium oxide powder after extrusion molding of the vanadium oxide powder.

The respective configurations of the refrigeration cycle apparatus 1 are not necessarily limited to those disclosed in the above-described embodiments. For example, in the refrigeration cycle 10 described in the above embodiments, there is described the example where the electric compressor is used as the compressor 11. However, the present disclosure is not necessarily limited to this. For example, an engine-driven compressor may be used as the compressor 11. A variable capacity compressor, which is configured to adjust a refrigerant discharge capacity of the compressor by changing a discharge capacity of the compressor, may be used as the engine-driven compressor.

In the refrigeration cycle 10 described in the above embodiments, the variable flow rate restrictor mechanism, which has the full closing function, is used as the cooling expansion valve 14 and the heat-absorbing expansion valve 15. However, the present disclosure should not be limited to this. For example, a thermostatic expansion valve, which adjusts a valve opening degree through a mechanical mechanism, or an electric opening/closing valve may be used in place of at least one of the cooling expansion valve 14 and the heat-absorbing expansion valve 15.

In the above embodiments, there is described the example where the mechanical thermostatic valve is used as the flow rate regulator 150. Alternatively, an electric flow rate regulating valve may be used as the flow rate regulator 150. In such a case, the control device 60 may sense the temperature of the coolant at a location that is on the upstream side of the heat storage 112, and the control device 60 may increase the opening degree of the electric flow rate regulating valve when this sensed temperature is increased.

The low-temperature-side coolant circuit 30 of the above embodiments mainly has the two circulation paths, i.e., the first low-temperature circulation path CL1 and the second low-temperature circulation path CL2. However, the present disclosure should not be limited to this. For example, the components, which form the second low-temperature circulation path CL2, except the low-temperature-side radiator 33 may be eliminated.

Furthermore, the present disclosure should not be limited to the above configuration where the high-temperature-side radiator 23 and the low-temperature-side radiator 33 are independently formed. For example, the high-temperature-side radiator 23 and the low-temperature-side radiator 33 may be integrated together such that the heat of the coolant, which is the high-temperature-side heat medium, and the heat of the coolant, which is the low-temperature-side heat medium, can be exchanged. Specifically, the high-temperature-side radiator 23 and the low-temperature-side radiator 33 may be integrated together such that some of the constituent components (e.g., the heat exchange fins) of the high-temperature-side radiator 23 and the low-temperature-side radiator 33 are shared between the high-temperature-side radiator 23 and the low-temperature-side radiator 33 to allow the heat exchange between the heat medium of the high-temperature-side radiator 23 and the heat medium of the low-temperature-side radiator 33.

Furthermore, in the above embodiments, the battery 40, the inverter 41, the electric charger 42 and the motor generator 43 are used as the temperature regulating subjects placed in the low-temperature-side coolant circuit 30. However, the temperature regulating subject(s) may be another type of device(s).

In the above embodiments, there is described the example where the electric pump is used as the engine coolant pump 26. Alternatively, the engine coolant pump 26 may be a pump that is driven by the drive force of the engine 70.

What is claimed is:

1. A heat storage device for a cooling system that includes: a heat exchanger, which is configured to release heat from coolant that is heated by a heat generating device at a time of operating the heat generating device; and a circulation path, which is configured to circulate the coolant between the heat generating device and the heat exchanger, the heat storage device comprising:
a heat storage, which is configured to store the heat released from the coolant;
a first flow passage, which is placed in a portion of the circulation path that conducts the coolant, wherein the heat storage is installed in the first flow passage;
a second flow passage, which is configured to conduct the coolant and bypass the heat storage; and
a flow rate regulator that is configured to adjust a flow rate ratio that is a ratio of a second flow rate of the coolant, which flows in the second flow passage, relative to a first flow rate of the coolant, which flows in the first flow passage, while the flow rate regulator is configured to reduce the first flow rate when a temperature of the coolant is decreased, wherein:
the heat exchanger includes:
a plurality of tubes that are respectively configured to conduct the coolant; and
a tank that forms a space at an inside of the tank and is configured to distribute the coolant into the plurality of tubes or collect the coolant from the plurality of tubes; and
the first flow passage and the second flow passage are located at the inside of the tank.

2. The heat storage device according to claim 1, wherein the flow rate regulator is located on an upstream side of the heat storage in a flow direction of the coolant.

3. The heat storage device according to claim 1, wherein the flow rate regulator is a thermostatic valve that is configured to reduce a size of a passage cross section, which conducts the coolant, in response to a decrease in the temperature of the coolant flowing in the thermostatic valve.
